(19) United States
(12) Patent Application Publication
(10) Pub. No.: US 2011/0292548 A1
(43) Pub. Date: Dec. 1, 2011

(54) HEAD GIMBAL ASSEMBLIES WITH WINDAGE DIVERSION FEATURES

(75) Inventors: Xu Zou, Prior Lake, MN (US); Sanjeev Sharma, Shakopee, MN (US); John S. Wright, Edina, MN (US)

(73) Assignee: Seagate Technology LLC, Scotts Valley, CA (US)

(21) Appl. No.: 12/786,546

(22) Filed: May 25, 2010

(51) Int. Cl. G11B 5/48

(52) U.S. Cl. 360/245; G9B/5.147

(57) ABSTRACT

A head gimbal assembly includes windage diversion structures that can comprise a base plate attached to the head gimbal assembly, a load beam, an actuator arm connected to the load beam, and a slider attached to the load beam. The base plate further comprises a grooved or channel portion that is oriented so that a plurality of grooves or channels diverts at least a portion of air flow away from the slider or load beam. A storage device and a method are also disclosed.

### BACKGROUND

Computer storage systems have included the use of hard disk drives. Typically, hard disk drives include at least one magnetic disk that rotates about a spindle. Data is written to and read from the magnetic disk by magnetic recording and reading heads incorporated on a slider. A support mechanism arm actuates the slider and head across the magnetic disk to access data.

### BRIEF SUMMARY

The present disclosure relates to a head gimbal assembly that has windage diversion features or structures that may include a base plate attached to the head gimbal assembly, a load beam, an actuator arm connected to the load beam, and a slider attached to the load beam. The base plate further includes a grooved portion that is oriented so that a plurality of groove channels diverts at least a portion of air flow away from the slider or load beam.

In certain embodiments, a storage device has at least one magnetic disk that rotates about a spindle axis and creates an air flow. A head gimbal assembly contains a base plate attached to the head gimbal assembly, a load beam, an actuator arm connected to the load beam and a slider attached to the load beam. The base plate forms a channel portion that is oriented so that a plurality of channels diverts at least a portion of the air flow away from at least one of the slider or the load beam.

In certain embodiments, methods of reducing windage to a head gimbal assembly (HGA) compose operating at least one magnetic disk by rotating the magnetic disk about a spindle axis and creating an air flow. A grooved portion on the HGA diverts the air flow to a slider attached to the HGA by a plurality of grooved channels oriented to divert the air flow away from the slider.

### BRIEF DESCRIPTION OF THE DRAWINGS

The disclosure may be more completely understood in consideration of the following detailed description of various embodiments in connection with the accompanying drawings, in which:

FIG. 1 shows a base plate on a HGA in accordance with certain embodiments;

FIG. 2 shows a HGA in accordance with certain embodiments with respect to a magnetic disk and the resultant air flow;

FIG. 3 shows an alternative base plate in accordance with certain embodiments;

FIG. 4 shows a cross-section of a base plate in accordance with certain embodiments;

FIG. 5 shows an alternative base plate with various divergence angles in accordance with certain embodiments;

FIG. 6A shows a graph plotting Displacement versus Frequency with a conventional HGA;

FIG. 6B shows a graph plotting Displacement versus Frequency with a HGA in accordance with certain embodiments;

FIG. 7 shows a graph plotting Displacement versus Frequency for various frequencies and designs.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The performance of hard disk drives can be dependent on certain problems that need solutions to enable better reliability and storage capacity. The magnetic disks spin at high speeds and can create air flow and windage issues within the hard disk drive. The air flow and windage effects can cause the slider and head performance to degrade. Specifically, the head gimbal assembly (HGA) can become excited by air flow and windage leading to problems such as non-repeatable run out (NRRO). Such issues may be exacerbated at the outside diameter (OD) of the magnetic disk. The terms windage and airflow are meant to include the same phenomenon of air or any gas or other fluid (i.e. helium) in relative movement inside the storage device.

The present inventors have recognized the need to reduce the adverse effects that windage and air flow can have to the internal workings of a hard disk drive.

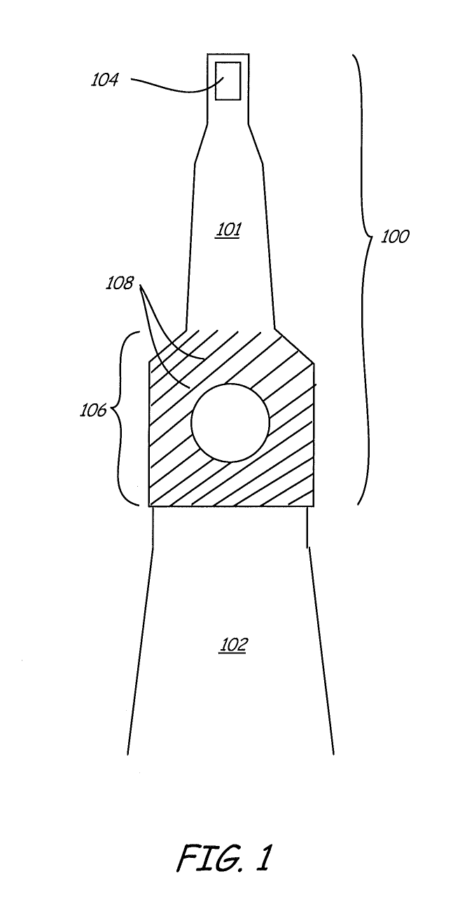

FIG. 1 shows a base plate 106 on a HGA 100 according to certain embodiments. The HGA 100 is attached to actuator arm 102 which provides for movement and support for the entire assembly. In some embodiments actuator arm 102 is attached to a voice coil motor to enable movement. HGA 100 also includes load beam 101 connecting slider 104 to the actuator arm 102 and base plate 106. Slider 104 may contain read and write elements to enable magnetic recording of data, and may also include other elements as appropriate like electric connectors and optical transducers.

Base plate 106 contains a grooved or channel portion that has a plurality of grooves or channels 108. These channels 108 divert air flow or windage away from the load beam 101 and slider 104 which may serve to reduce adverse consequences of undesired airflow. Examples of such adverse consequences include windage excitation on the HGA load beam 101 and slider 104 area. In some cases, windage excitation can cause non-repeatable run out (NRRO) errors that can be written to the disc. This problem can be further exacerbated in applications such as multi-disc writing (MDW) applications, including servo formatting aspects. MDW application can include more than one magnetic disc to write to and the associated circuitry and controllers to enable this application. In some embodiments, a MDW application will be utilized to format and/or write servo information to a storage disc.

In some embodiments, grooves 108 are located on a medium or media facing side of HGA 100. This allows for effective divergence of the airflow since the slider 104 is also located on the media facing side of HGA 100.

Grooves 108 can be imprinted, stamped or machined directly onto base plate 106 during manufacture of the base plate. Alternatively, grooves 108 can be located on a separate film that can be attached to base plate 106 using any method know in the art including attachment with an adhesive. In some embodiments, base plate 106 can be part of an e-block. An e-block is understood by one of ordinary skill in the art to include an actuator arm assembly with multiple arms or appendages spaced apart from each other vertically and including a head on one end. The appendages are connected together on the other end such that, in embodiments with three appendages, a side view resembles the letter “E.” The e-block can have 2 or more than 3 appendages.

Grooves 108 can also be referred to as riblets, ridges or other like terms. In some embodiments, an additional benefit from having grooves 108 is to modify the double layer air flow transition above the base plate 106. This can result in less disturbance caused by vortex shedding of the airflow.

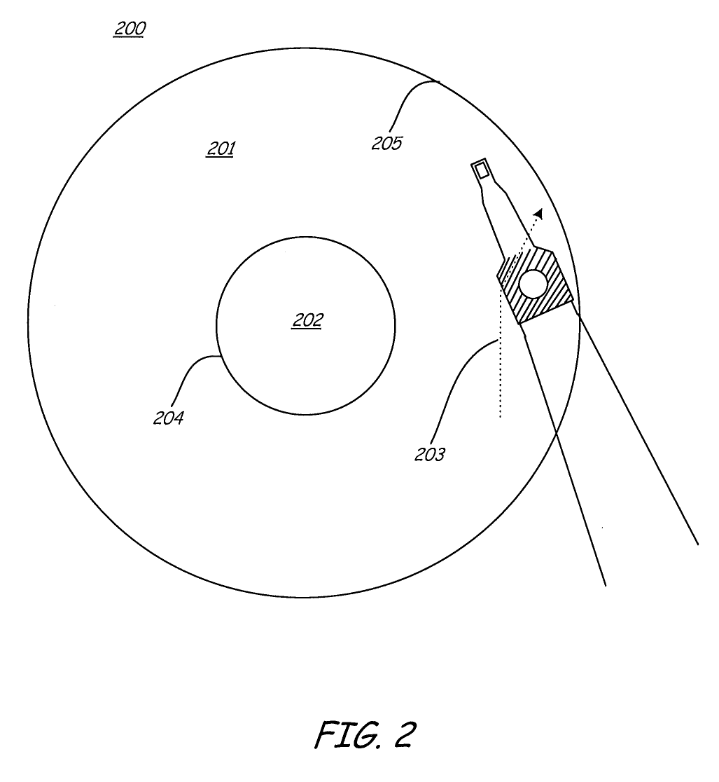

FIG. 2 depicts a storage device 200 with a HGA according to certain embodiments with respect to a magnetic disc 201 and the resultant air flow 203. The elements of the HGA are similar to those shown in FIG. 1 and are not being reproduced in this Figure for clarity purposes.

Magnetic disc 201 includes a spindle axis 202 that it can rotate around. Disc 201 has an inner diameter 204 and an outer diameter 205. The negative effects of windage excitation are more pronounced at outer diameter 205 and thus create a greater need for airflow 203 to be diverted in those regions.

As can be seen by the dashed arrow depicting airflow 203, grooves 108 divert or deflect the direction of air travel such that the bulk of the air flow does not directly strike the slider 104 and/or load beam 101. It should be understood that only a portion of the airflow 203 needs to be diverted.

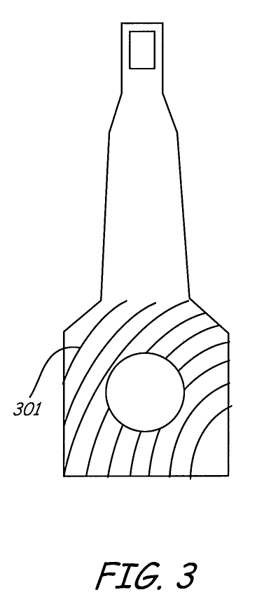

As illustrated in FIG. 3, an alternative base plate design may utilize curved grooves or channels 301. In some embodiments, the curved grooves 301 can provide better air diversion to reduce windage excitation. Curved grooves 301 can have any geometric arc shape that maintains the property of diverting airflow away from the transducer and/or load beam.

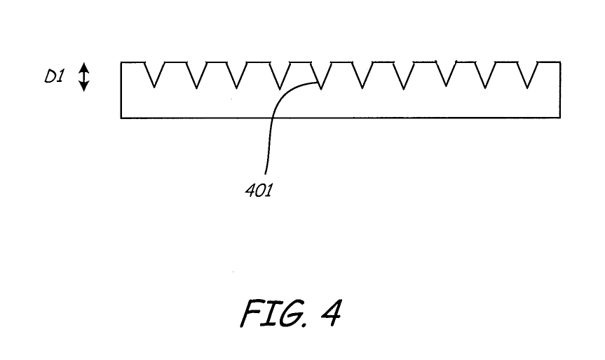

Illustrated in FIG. 4, is a cross-section view of baseplate 106 taken perpendicular to grooves 108. In the depicted embodiment, the grooves 108 have a V-shape 401. Alternatively, the grooves 108 could have any number of other shapes including a square or rectangular shape, a U-shape or a rounded shape. Grooves 108 can be embedded in baseplate 106 or raised above baseplate 106. The depth D1 of the grooves can be optimized based on the application. In some embodiments, depth D1 can be between 0.0025 inches and 0.004 inches. Spacing between the grooves can be between 0.0025 inches and 0.004 inches in some embodiments. In some embodiments, grooves 108 are located 0.005 to 0.015 inches away from an adjacent medium disc at a closest point (i.e. the tip of V-shapes 401).

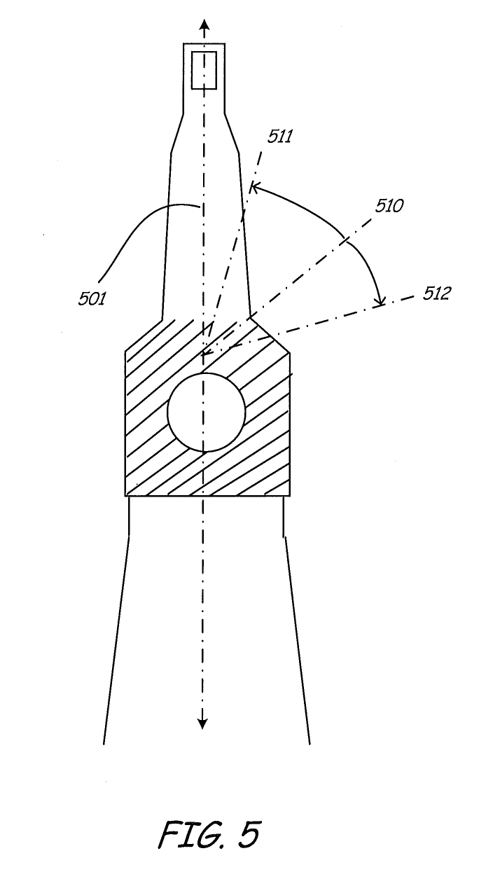

As illustrated in FIG. 5, grooves 108 can have various orientation angles 510 in relation to the longitudinal axis 501 of load beam 101. Orientation angle 510 can be any angle greater than but not including 0 degrees or less than but not including 90 degrees. In some embodiments orientation angle 510 can be between 20 degrees 511 from longitudinal axis 501 and 70 degrees 512. In other embodiments the orientation angle 510 is between 10 and 80 degrees from longitudinal axis 501. In still other embodiments the orientation angle 510 is between 30 and 60 degrees from longitudinal axis 501. In still other embodiments the orientation angle 510 is set at 45 degrees from longitudinal axis 501.

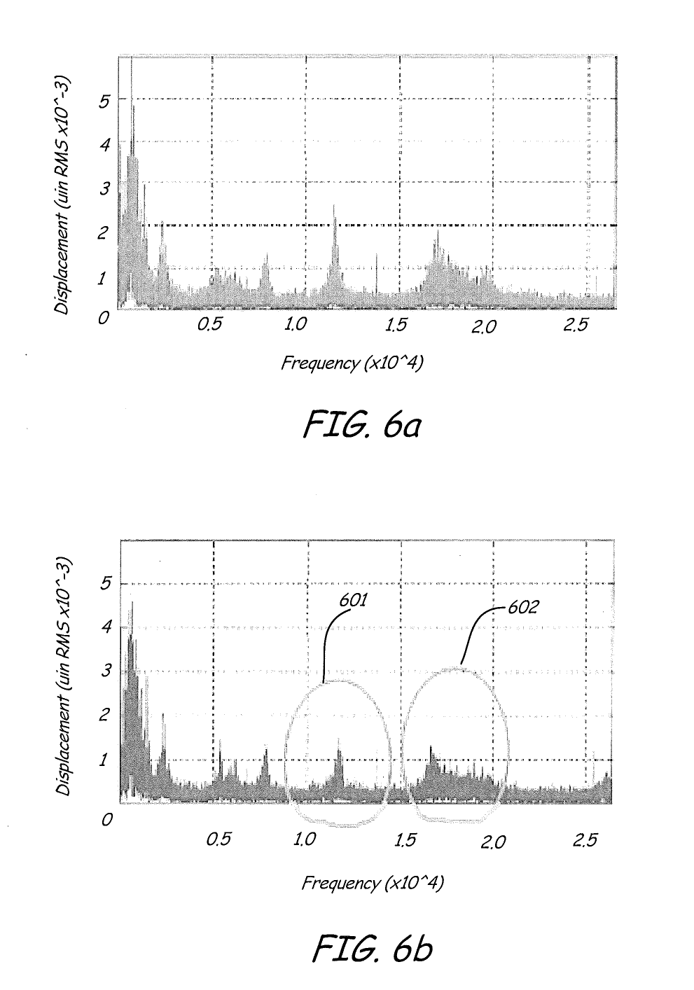

FIGS. 6A and 6B, compare the graphical results of NRRO performance between devices with and without an air diverting grooved portion on the HGA base plate. FIG. 6A shows the baseline results of a device without an air diverting grooved portion on the HGA base plate. This graph depicts NRRO displacement on the y-axis as related to various frequencies on the x-axis. FIG. 6B shows the same except for a device with an air diverting grooved portion on the HGA base plate. Note highlighted portions 601 and 602 where the unexpected results of a 20-30% improvement in NRRO can be seen at outer diameters.

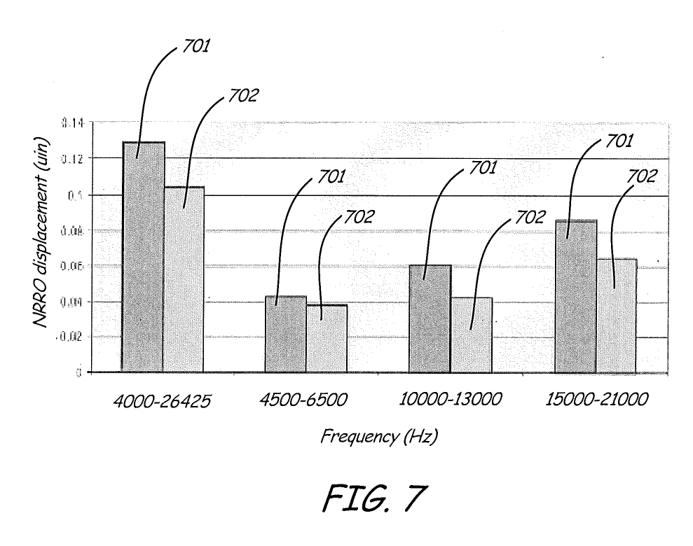

FIG. 7 again shows improvements that can be realized with certain embodiments over previous devices without air diverting grooved portions on the HGA base plate. Bars 701 depict the NRRO displacement of non-air diverting designs at various frequencies. Bars 702 likewise depict the improved lesser NRRO displacement for devices implementing certain embodiments.

In the preceding description, reference is made to the accompanying set of drawings that form a part hereof and in which are shown by way of illustration several specific embodiments. It is to be understood that other embodiments are contemplated and may be made without departing from the scope or spirit of the present invention. The detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Thus, embodiments of the HEAD GIMBAL ASSEMBLIES WITH WINDAGE DIVERSION FEATURES are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. An apparatus comprising:
a base plate attached to a head gimbal assembly;
a load beam;
an actuator arm connected to the load beam; and
a slider attached to the load beam wherein the base plate comprises a grooved portion that is oriented so that a plurality of groove channels divert at least a portion of air flow away from at least one of the slider or the load beam.

2. The apparatus of claim 1, wherein the grooved portion is located 0.005 to 0.015 inches away from a medium disc at a closest point.

3. The apparatus of claim 1, wherein the grooved portion is a film attached to the base plate.

4. The apparatus of claim 1, wherein the grooved channels are curved.

5. The apparatus of claim 1, wherein the grooved channels are linear.

6. The apparatus of claim 1, wherein the grooved portion is on a media facing side of the base plate.

7. The apparatus of claim 1, wherein the grooved portion is oriented at an angle between 20 degrees and 70 degrees relative to a longitudinal axis of the load beam.

8. The apparatus of claim 1, wherein the grooved portion is oriented to divert at least a portion of air flow at an outside diameter (OD) of an adjacent magnetic disk.

9. The apparatus of claim 1, wherein the grooved channels are v-shaped.

10. The apparatus of claim 1, wherein the grooved channels have a groove height wherein the groove height is in the range of 0.0025 to 0.004 inches.

11. A storage device comprising:
at least one magnetic disk that rotates about a spindle axis and creates an air flow;
a head gimbal assembly comprising:
a base plate attached to the head gimbal assembly;
a load beam;
an actuator arm connected to the load beam; and
a slider attached to the load beam wherein the base plate comprises a channel portion that is oriented so that a plurality of channels divert at least a portion of the air flow away from at least one of the slider or the load beam.

12. The storage device of claim 11, wherein the plurality of channels are oriented at an angle between 20 degrees and 70 degrees relative to a longitudinal axis of the load beam.

13. The storage device of claim 11, wherein the channels are curved.

14. The storage device of claim 11, wherein the channel portion is oriented to divert at least a portion of the air flow at an outside diameter (OD) of the magnetic disk.

15. The storage device of claim 11, wherein the at least one magnetic disk comprises at least two magnetic disks which are configured for multi-disk writing (MDW).

16. A method of reducing windage to a head gimbal assembly (HGA) comprising the steps of:
operating at least one magnetic disk by rotating the magnetic disk about a spindle axis and creating an air flow;
diverting the air flow to a slider attached to the HGA by providing a grooved portion on the HGA that includes a plurality of grooved channels oriented to divert the air flow away from the slider.

17. The method of claim 16, wherein the plurality of grooved channels are oriented at an angle between 20 degrees and 70 degrees relative to a longitudinal axis of the HGA.

18. The method of claim 16, wherein the grooved channels are curved.

19. The method of claim 16, wherein the diverting step causes an improvement in non-repeating run out (NRRO) of a slider attached to the HGA while operating at least at an outer diameter of the magnetic disk.

20. An apparatus comprising windage diversion structures positioned between an actuator arm and a load beam and oriented to divert at least a portion of air flow away from at least one of the load beam or a slider attached to the load beam.

21. The apparatus of claim 20, wherein the windage diversion structures are oriented at an angle between 20 degrees and 70 degrees relative to a longitudinal axis of the load beam.
